(19) United States
(12) Patent Application Publication
(10) Pub. No.: US 2019/0180664 A1
(43) Pub. Date: Jun. 13, 2019

(54) DISPLAY DEVICE AND PRIVACY PROTECTING METHOD THEREOF

(71) Applicant: Acer Incorporated, New Taipei City (TW)

(72) Inventors: Chia-Yu Sun, New Taipei City (TW); Jin-Ting Kuo, New Taipei City (TW)

(73) Assignee: Acer Incorporated, New Taipei City (TW)

(21) Appl. No.: 15/889,213

(22) Filed: Feb. 6, 2018

(30) Foreign Application Priority Data
Dec. 7, 2017 (TW) 106142917

(51) Int. Cl. G09G 3/20; G06F 21/84

(52) U.S. Cl. CPC G09G 3/20; G06F 21/84; G09G 2320/0686; G09G 2358/00; G09G 2320/068

(57) ABSTRACT

A display device and privacy protecting method thereof are provided. The privacy protecting method includes: analyzing a display image on a display panel to determine at least one privacy information region in the display image; configuring at least one privacy protecting region on a privacy protecting mask according to a first area or a first position of the at least one privacy information region, so that a viewing angle of the privacy information region is limited by the privacy protecting region, and a viewing angle of other region in the display image is not limited; detecting whether the first area or the first position is changed; and correspondingly changing a second area or a second position of the at least one first privacy protecting region when the first area or the first position of the at least one privacy information region is changed.

### CROSS-REFERENCE TO RELATED APPLICATION

This application claims the priority benefit of Taiwan application serial no. 106142917, filed on Dec. 7, 2017. The entirety of the above-mentioned patent application is hereby incorporated by reference herein and made a part of this specification.

### BACKGROUND OF THE INVENTION

### Field of the Invention

The invention relates to a display device, and particularly relates to a display device capable of adjusting a viewing angle of a part of a display image and a privacy protecting method thereof.

### Description of Related Art

Generally, a screen of a display device generally has a wide viewing angle display effect, though in some cases, for example, in case that personal data or other classified data is processed in public places, the wide viewing angle display effect is easy to make the processed data to be peeped by others to cause private data leakage. A conventional privacy protecting method is to add a privacy protecting film on the screen of the display device to achieve a function of reducing the viewing angle of the full display image. However, besides that the privacy protecting film is easy to influence display quality, viewing angle adjustment of a part of the display image cannot be implemented.

Therefore, it is necessary to provide a display device and a privacy protecting method thereof to dynamically adjust a viewing angle of a part of the display image according to a usage requirement.

### SUMMARY OF THE INVENTION

The invention is directed to a display device and a privacy protecting method thereof, which are adapted to dynamically adjust a viewing angle of a part of a display image according to a privacy information region in the display image.

An embodiment of the invention provides a privacy protecting method. The privacy protecting method includes: analyzing a display image on a display panel so as to determine at least one privacy information region in the display image; configuring at least one privacy protecting region on a privacy protecting mask according to at least one of a first area and a first position of the at least one privacy information region, so that a viewing angle of the privacy information region is limited by the privacy protecting region of the privacy protecting mask, and a viewing angle of other region in the display image is not limited; detecting whether at least one of the first area and the first position is changed; and changing at least one of a second area and a second position of the privacy protecting region of the privacy protecting mask in case that at least one of the first area and the first position of the privacy information region is changed.

An embodiment of the invention provides a display device including a display panel, a display image analyzing module, a privacy protecting mask and a control module. The display panel is configured to display a display image. The display image analyzing module is configured to analyze the display image to determine at least one privacy information region in the display image. The privacy protecting mask is disposed on the display panel. The control module is coupled to the display panel, the display image analyzing module and the privacy protecting mask. The control module configures at least one privacy protecting region on the privacy protecting mask according to at least one of a first area and a first position of the at least one privacy information region, so that a viewing angle of the privacy information region is limited by the privacy protecting region of the privacy protecting mask, and a viewing angle of other region in the display image is not limited. The control module detects whether at least one of the first area and the first position is changed. If it is detected that at least one of the first area and the first position of the privacy information region is changed, the control module accordingly changes at least one of a second area and a second position of the privacy protecting region of the privacy protecting mask.

An embodiment of the invention provides a privacy protecting method. The privacy protecting method includes: detecting a position of a display device; and determining whether to activate a privacy protecting mask to limit a viewing angle of at least one privacy information region in a display image of a display panel according to the position of the display device.

An embodiment of the invention provides a display device including a display panel, a privacy protecting mask, a position detecting circuit and a control module. The display panel is configured to display a display image. The privacy protecting mask is disposed on the display panel. The position detecting circuit is configured to detect a position of the display device. The control module is coupled to the display panel, the privacy protecting mask and the position detecting circuit. The control module determines whether to activate the privacy protecting mask to limit a viewing angle of at least one privacy information region in the display image of the display panel according to the position of the display device.

According to the above description, the display device and the privacy protecting method thereof are adapted to automatically detect whether an application executed by a user has privacy information, so as to adjust a viewing angle of a part of region of the display image to implement privacy protection.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit block schematic diagram of a display device according to an embodiment of the invention.

FIG. 2 is a schematic diagram of a driving structure of a display panel according to an embodiment of the invention.

FIG. 3 is a schematic diagram of adjusting a viewing angle according to an embodiment of the invention.

FIGS. 4A-4E are flowcharts illustrating privacy protecting methods according to different embodiments of the invention.

FIGS. 5A-5C are schematic diagrams of shift and change of a privacy information region according to an embodiment of the invention.

FIG. 6 is a flowchart illustrating a privacy protecting method according to another embodiment of the invention.

FIGS. 7A-7B are schematic diagrams of adjusting a viewing angle according to another embodiment of the invention.

FIG. 8 is a schematic diagram of a privacy protecting strategy of a mask database according to an embodiment of the invention.

### DESCRIPTION OF EMBODIMENTS

Wherever possible, components/members/steps using the same referential numbers in the drawings and description refer to the same or like parts. Components/members/steps using the same referential numbers or using the same terms in different embodiments may cross-refer related descriptions.

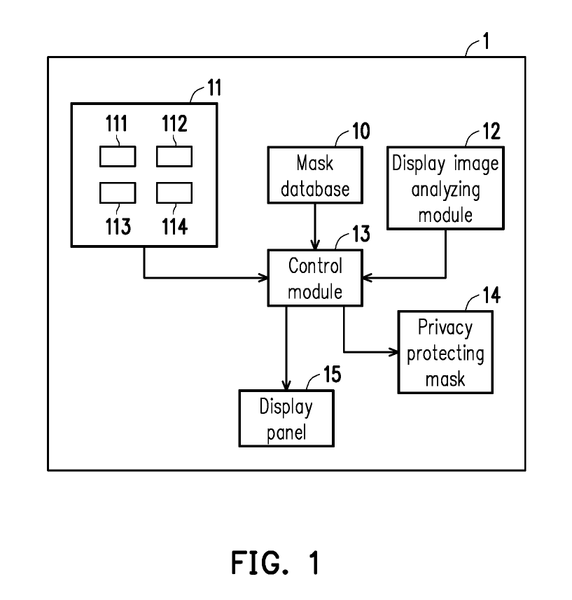

FIG. 1 is a circuit block schematic diagram of a display device according to an embodiment of the invention. The display device 1 includes a position detecting circuit 11, a display image analyzing module 12, a control module 13, a privacy protecting mask 14 and a display panel 15. The display panel 15 may present a display image. The display image analyzing module 12 may analyze the display image to determine a position in the display image required to configure a privacy information region. The position detecting circuit 11 may detect a position of the display device 1. The control module 13 is coupled to the position detecting circuit 11, the display image analyzing module 12, the privacy protecting module 14 and the display panel 15. The privacy protecting module 14 is disposed on the display panel 15. By controlling a privacy protecting region configured on the privacy protecting mask 14, viewing angle adjustment is performed to a partial region of the display image, for example, to limit a viewing angle of the privacy information region without limiting a viewing angle of other region in the display image, so as to protect privacy.

The position detecting circuit 11 includes a positioning circuit 111, a height detecting circuit 112 and an image sensing circuit 113. The positioning circuit 111, for example, detects a horizontal position (latitude and longitude) of the display device 1 through a global positioning system (GPS) device. The height detecting circuit 112, for example, detects a height (the height of a floor where the display device 1 is located) of the display device 1 through a height detector. The image sensing circuit 113, for example, captures an environment image of the display device 1 through a camera lens of the display device 1, and the control module 13 captures at least one position feature from the environment image to determine the position of the display device. Therefore, the position detecting circuit 11 may be used for determining whether the display device 1 is in a private place or a public place.

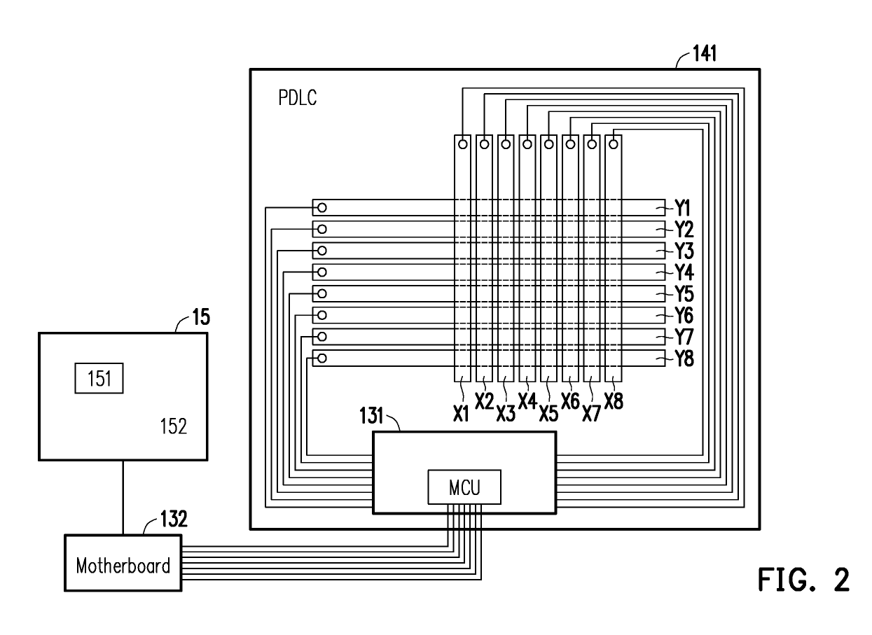

FIG. 2 is a schematic diagram of a driving structure of a display panel according to an embodiment of the invention. Referring to FIG. 1 and FIG. 2, the privacy protecting mask 14 of the present embodiment is a polymer dispersed liquid crystal (PDLC) film integrated with the display panel 15. The PDLC film 141 is electrically connected to a control chip 131, and is connected to a motherboard 132 of the display device 1 through an inter-integrated circuit (I²C) interface. The control chip 131 may be configured with a microcontroller unit (MCU) for controlling the PDLC film 141, and transforms a region on the display panel 15 that has to be masked into a region on the PDLC film 141.

For example, the region on the display panel 15 to be masked corresponds to a region on the PDLC film 141 in a proportional manner, and channels on the PDLC film 141 to be activated are selected through a voltage value applied to the PDLC film 141. For example, if a resolution of the display panel 15 is Rx*Ry, the region to be masked is (X1,Y1) to (X2,Y2), and the number of channels of the PDLC 141 is CHx*CHy, the number of the channels of the PDLC film 141 to be activated may be represented by a following expression:

X axis: from (CHx*X1)/Rx to (CHx*X2)/Rx;

Y axis: from (CHy*X1)/Ry to (CHy*X2)/Ry.

Therefore, a proper number of channels of the PDLC film 141 may be activated according to the above method, and packet control is transceived through the I2C interface in order to mask an appointed region in the display image.

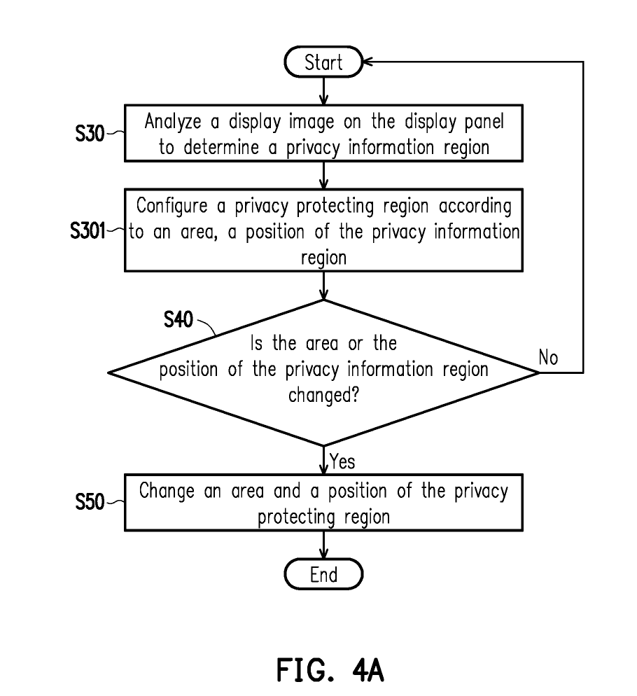

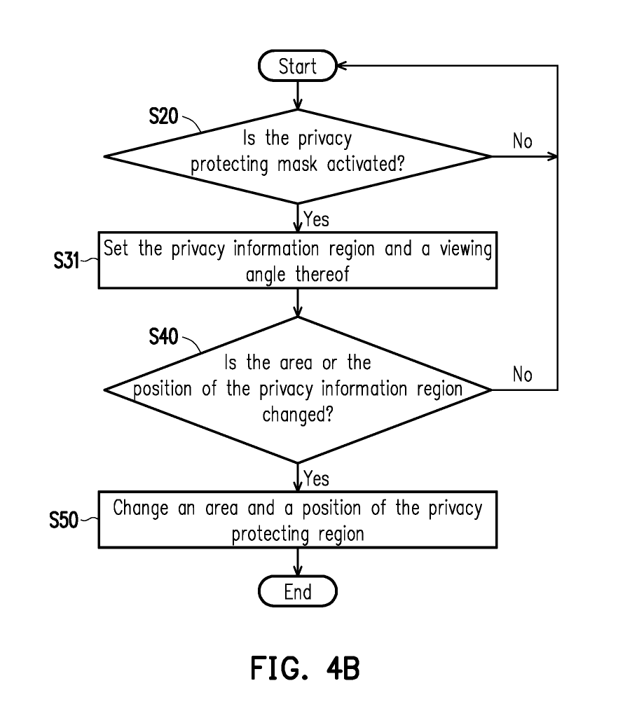

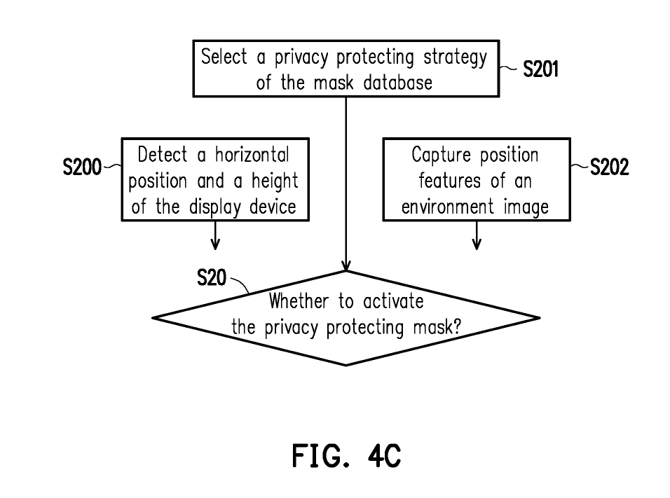

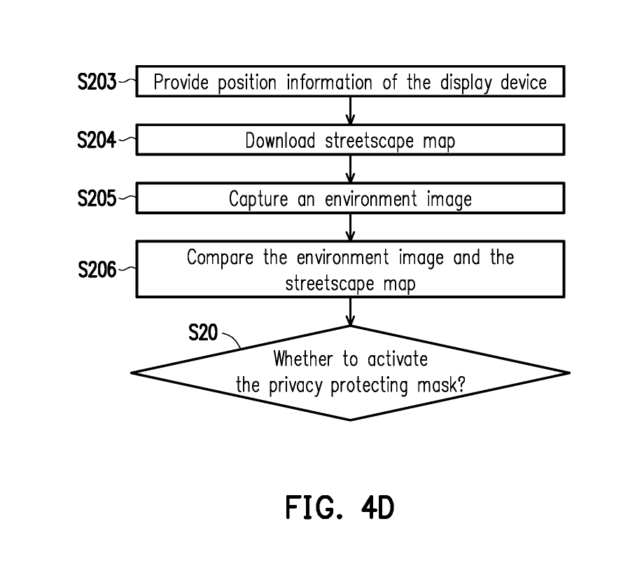

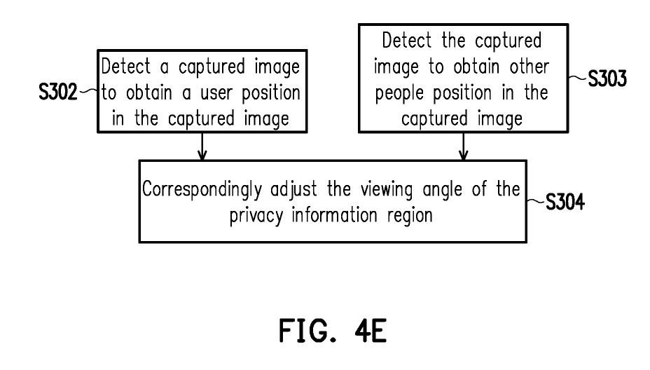

FIG. 4A is a flowchart illustrating a privacy protecting method according to an embodiment of the invention. Referring to FIG. 1 and FIG. 4, in step S30, the display image analyzing module 12 analyzes a display image on the display panel 15 to determine a configuration position of a privacy information region. A following table 1 lists analyzing information of the display image analyzing module 12 according to an embodiment of the invention. As shown in the table 1, the display image probably has windows of a plurality of applications AP1-AP8. The display image analyzing module 12 may detect the application executed by the display device 1, and transmit related analyzing data such as a name of the application, whether confidential information is contained and a location (represented by an X coordinate and a Y coordinate) of the confidential information, etc. to the control module 13, so as to determine and area and a position of the privacy information region in the display image. The display image analyzing module 12 may further detect whether the application executed by the display device 1 contains a specific privacy information feature to obtain a detection result. According to a design requirement, the privacy information feature may include “password”, “confidential”, “secret”, “code number”, “account number”, “log in”, “sign in”, “register”, “birthday”, “name”, “ID number” (or “identification number”), “verification code” or other keywords (or text image) appeared in the display image, or a dynamic keyboard, a software keyboard or other image/object appeared in the display image. The display image analyzing module 12 may transmit the detection result to the control module 13 to determine whether an application including specific privacy information is activated.

TABLE 1

| | Confidential information | Location of confidential |
|---|---|---|
| Name of application | contained? | region |
| AP1 | No | None |
| AP2 | No | None |
| AP3 | Yes | AP3 (X1, Y1, X2, Y2) |
| AP4 | No | None |
| AP5 | Yes | AP5 (X1, Y1, X2, Y2) |
| AP6 | Yes | AP6 (X1, Y1, X2, Y2) |
| AP7 | Yes | AP7 (X1, Y1, X2, Y2) |
| AP8 | No | None |

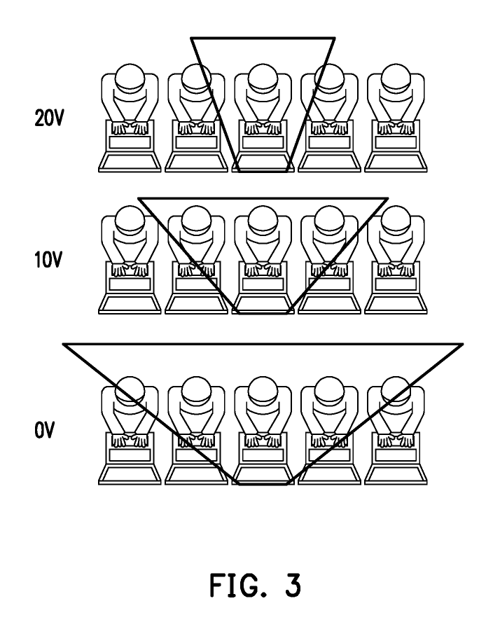

After the area and the position of the privacy information region in the display image are determined, the control module 13 configures the required number of privacy protecting regions on the privacy protecting mask 14 (step S301). The privacy protecting region of the privacy protecting mask 14 may limit a viewing angle of the privacy information region of the display panel 15. For example, the viewing angle of the privacy information region may be adjusted through a voltage value applied to the privacy protecting mask 14, as shown in FIG. 3, different applied voltage may influence a haze value of the privacy protecting mask 14, for example, when a saturation voltage is 20V, the privacy protecting mask 14 is completely transparent, and the viewing angle reaches the minimum value; when the saturation voltage is 10V, the privacy protecting mask 14 is semi-hazed, and the viewing angle is expanded; and when none voltage is applied to the privacy protecting mask 14, a wide viewing angle display effect is achieved.

Then, the display image analyzing module 12 continually detects whether the area or the position of the privacy information region is changed (step S40), for example, whether a window containing the privacy information is shifted or enlarged/diminished. If it is detected that the area or the position of the privacy information region is changed, a step S50 is executed, by which the control module 13 accordingly changes an area and a position of the privacy protecting region, for example, resets the area or the position of the privacy protecting region according to the shift and the size change of the window containing the privacy information, so as to correspondingly set a new privacy information region in the display image.

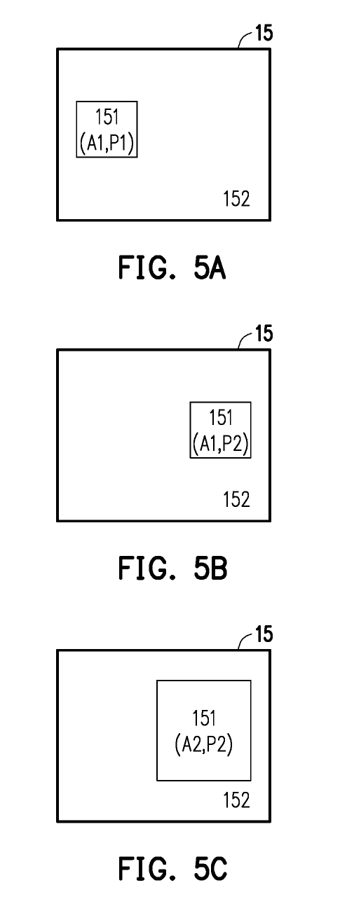

FIGS. 5A-5C are schematic diagrams of shift and change of the privacy information region according to an embodiment of the invention. If the window containing the privacy information is shifted or a size thereof is changed, the executed application may notify the control module 13 through an application programming interface of the display device 1, so as to synchronously change a mask range. For example, as shown in FIG. 5A, the display image of the display panel 15 is divided into a privacy information region 151 and a non-privacy information region 152. In FIG. 5A, an area of the privacy information region 151 is A1, and a center position of the privacy information region 151 is P1. As shown in FIG. 5B, when the window containing the privacy information is moved to a position P2, the privacy information region 151 is correspondingly moved to the position P2. As shown in FIG. 5C, if the window containing the privacy information is enlarged at the position P2, the area of the privacy information region 151 is synchronously enlarged to an area A2, so as to achieve the effect of tracking the privacy information.

FIG. 4B is a flowchart illustrating a privacy protecting method according to another embodiment of the invention. Referring to FIG. 1 and FIG. 4B, the control module 13 first determines whether to activate the privacy protecting mask 14. If it is determined that it is unnecessary to activate the privacy protecting mask 14, the display device 1 maintains the wide angle display state, and if it is determined that it is required to activate the privacy protecting mask 14, a privacy information region is set in the display image and a viewing angle of the privacy information region is set (step S31). Then, the display image analyzing module 12 continually detects whether the area or the position of the privacy information region is changed (step S40), and if it is detected that the area or the position of the privacy information region is changed, the step S50 is executed, by which the control module 13 accordingly changes the area and the position of the privacy protecting region, so as to correspondingly set a new privacy information region in the display image.

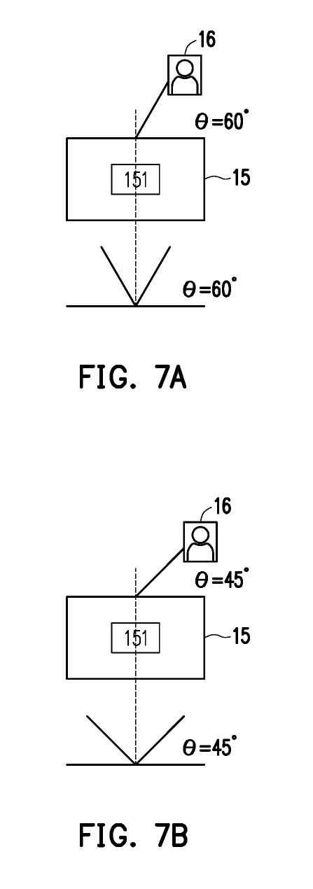

A range of the privacy information region may be set according to the area and the position of the window containing the privacy information, and the viewing angle of the privacy information region may be set according to a relative position between a stranger around the user and the display image. For example, the image sensing circuit 113 in the display device 1 may detect whether a stranger is approaching to the back of the user, and records a relative angle between the stranger behind the user and the display screen, so as to determine a viewing angle of the display image required to be switches. As shown in FIG. 7A, it is assumed that the privacy information region 151 is located at the center position of the display image, when a stranger 16 is close to the privacy information region 151, the display panel 15 is required to set a narrow viewing angle. When the stranger 16 is away from the privacy information region 151, as shown in FIG. 7B, the display panel 15 is required to set a larger viewing angle.

FIG. 4E is a flowchart illustrating a privacy protecting method according to still another embodiment of the invention. In an embodiment, the image sensing circuit 113 captures an image of the user or other people around the user through a camera lens of the display device 1, and the control module 13 detects the captured image to obtain a user position in the captured image (step S302) or the control module 13 detects the captured image to obtain other people position in the captured image (step S303). Then, the control module 13 controls the privacy protecting mask 14 according to the user position or other people's position in the captured image to correspondingly adjust the viewing angle of the privacy information region 151 (step S304). Therefore, the control module 13 may monitor a relative position between the user and the others according to the captured image of the image sensing circuit 113, so as to dynamically switch the viewing angle of the display device 1. However, if it is found someone is just standing behind the user through the captured image, the control module 13 may also control the privacy protecting mask 14 to completely shield the privacy information presented by the display image, so as to prevent the privacy information from being peeped by others.

FIG. 4C is a flowchart illustrating a determination flow for activating the privacy protecting mask according to an embodiment of the invention. Referring to FIG. 1 and FIG. 4C, the position detecting circuit 11 detects a position of the display device 1 to determine whether to activate the privacy protecting mask 14 (step S20), for example, the positioning circuit 111 detects a horizontal position of the display device 1 while the height detecting circuit 112 detects a height of the display device 1 (step S200) or position features of an environment image are captured (step S202), for example, the image sensing circuit 113 captures the environment image of the display device 1, and determines the position of the display device 1 according to obvious position features in the environment image, so as to determine whether to activate the privacy protecting mask 14 (step S20). For example, the camera lens of the display device 1 may capture the environment image around the user, where the environment image may present position features such as a high building (for example, Taipei 101) or a LOGO of a specific company (for example, ACER), etc., and though the position features, it is learned whether the display device 1 is in a private or public place, so as to determine whether to activate the privacy protecting mask 14.

Moreover, as shown in FIG. 4C, the user also creates an exclusive mask database 10 in the display device 1, and sets a specific privacy protecting strategy, and selects the privacy protecting strategy of the mask database (step S201) to determine whether to activate the privacy protecting mask 14 (step S20). For example, the user may sets an information list of the privacy protecting strategy in the mask database 10, as that shown in a table 2, the information list of the privacy protecting strategy may includes information such as an application name, a website address, a window title, whether the entire window is masked or only a sub window is masked, etc. The user may determine whether to activate the privacy protecting mask 14 according to different application types. When the user opens a website (for example, Brower in the table 2), the user may determine whether to activate the privacy protecting mask 14 according to the privacy protecting strategy of the website, and if the user opens a file (for example, MS word in the table 2), the user may determine whether to activate the privacy protecting mask 14 according to the privacy protecting strategy of the file.

TABLE 2

| | App. | | | Total | Sub window |
|---|---|---|---|---|---|
| | name | Website | Window title | mask | information |
| 1 | Brower | https://salary.hq.- | e-Payslip | Yes | None |
| | | intra.acer.com/ | System - | | |
| | | UI/Common/ | Internet Explorer | | |
| | | Login.aspx | | | |
| 2 | MS | None | PDLC.docx - | Yes | None |
| | Word | | Microsoft Word | | |

Moreover, a privacy protecting strategy related to privacy information features may be created in the mask database 10. The privacy information features may include a text or an image of a password, a code number, an account number, log in, sign in, register, a birthday, a name, an ID number, a verification code, a dynamic keyboard, a software keyboard, a Password, Confidential, Secret, Sing In, etc., or other corresponding languages. If the display image only has the privacy information features, but the display image dose not has the privacy information, it is unnecessary to activate the privacy protecting mask 14. For example, a key “log in” is generally presented on a home page of a bank website for user's inquiry, for example, to inquire transaction details of a credit card, and if the user only inquires public information of the bank, the user is unnecessary to click the key “log in”, so that the display image does not show any privacy information of the user, and now the control module 13 determines that it is unnecessary to activate the privacy protecting mask 14.

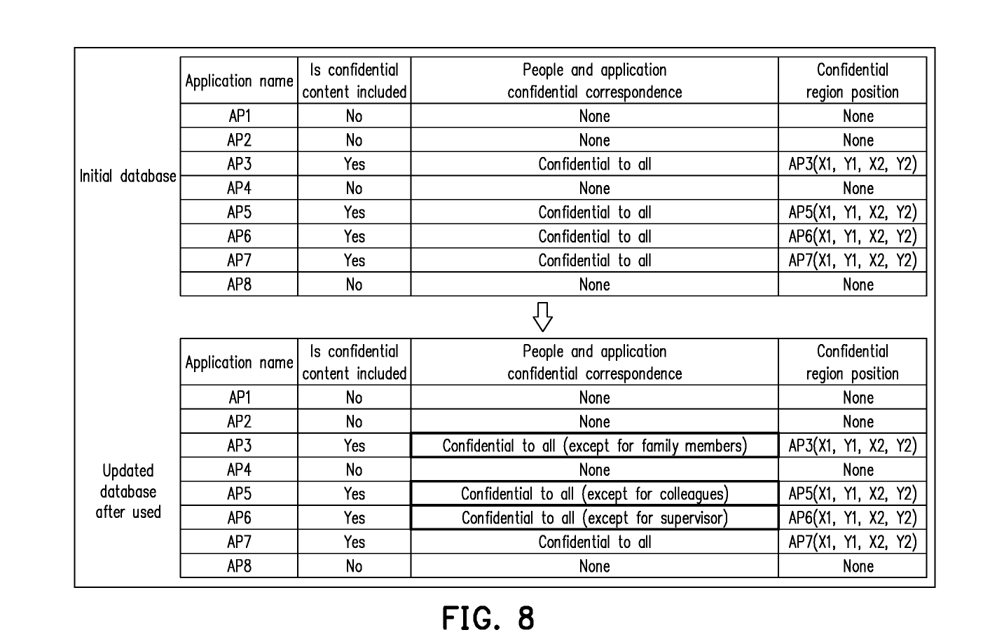

FIG. 8 is a schematic diagram of a privacy protecting strategy of a mask database according to an embodiment of the invention. Since the privacy information and people have a corresponding relationship, it is required to create an identification list in the mask database 10 to serve as the privacy protecting strategy, so as to identify the corresponding relationship between each people (for example, family member, colleague, supervisor, stranger, etc.) and the privacy information. As shown in FIG. 8, when the mask database 10 is created for the first time, only the user may be able to view the privacy information, so that when other people is around the user, the privacy protecting mask 14 is automatically activated, and along with growing of a usage course, correspondence of a confidential state may be updated along with user's demand, for example, some information is non-confidential to family members, and when a family member is approaching the user, it is unnecessary to activate the privacy protecting mask 14; and some information is non-confidential to the supervisor, and when the supervisor is around the user, it is unnecessary to activate the privacy protecting mask 14.

FIG. 4D is a flowchart illustrating a determination flow for activating the privacy protecting mask according to another embodiment of the invention. Referring to FIG. 1 and FIG. 4D, the position detecting circuit 11 of the display device 1 may be further configured with a communication circuit 114, and the communication circuit 114 is coupled to the control module 13. In step S203, the positioning circuit 111 provides position information of the display device 1, and the communication circuit 114 downloads at least one streetscape map from the Internet according to the position information provided by the positioning circuit 111 (step S204). Then, the image sensing circuit 113 captures the environment image of the display device 1 (step S205), and the control module 13 compares the environment image with the streetscape map (step S206). Therefore, the control module 13 deduces an accurate position of the display device 1 according to the position information provided by the positioning circuit 111 and the comparison result, so as to determine whether to activate the privacy protecting mask 14 (step S20).

For example, the communication circuit 14 may be a global system for mobile communication (GSM), a third generation (3G), or a fourth generation (4G) or wired or wireless network interface circuits of other mobile communication techniques. The communication circuit 14 may be connected to the Internet, and find the streetscape map of a street near the display device 1 according to address information detected by the positioning circuit 111. The image sensing circuit 113 may determine whether clothing on characters in the environment image captured by the camera lens of the display device 1 includes a specific image or mark (for example, specific information such as an ID, a name, or a company name, etc.). The control module 13 compares the specific information with the streetscape map to seek same objects from the environment image and the streetscape map, so as to deduce the accurate position of the display device 1.

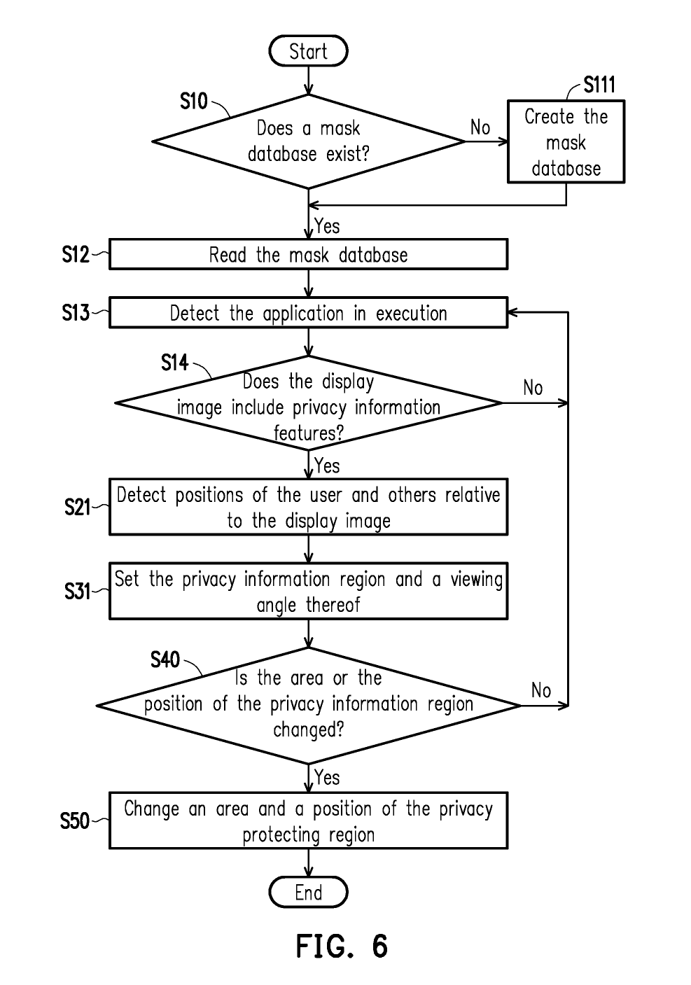

FIG. 6 is a flowchart illustrating a privacy protecting method according to another embodiment of the invention. Referring to FIG. 1 and FIG. 6, in step S10, the control module 13 first determines whether the display device 1 has the mask database 10, and if the mask database 10 does not exist, the control module 13 creates the mask database 10 (step S11). Since the display image analyzing module 12 may detect whether the display image includes a region required to be masked according to user's demand, when the display device 1 is used for the first time, the user requires to create the mask database 10 to store a privacy protecting strategy related to the mask. The user may set the types of information required to be masked in the mask database 10, for example, booting login, a website login window, a specific application window, a game window, etc., and the windows are independent to each other.

It should be noted that in different application situations, related functions of the display image analyzing module 12 may be implemented as software, firmware or hardware by general programming languages (for example, C or C++), hardware description languages (for example, Verilog HDL or VHDL) or other proper programming languages.

If the mask database has been created by the user, the mask database may be read (step S12). Then, the display image analyzing module 12 detects the application in execution (step S13), and determines whether the display image contains privacy information features (step S14). If the display image contains the privacy information features, positions of the user and others relative to the display image are detected (step S21), so as to set a privacy protecting region according to a privacy information distribution status, and the relative relationship between the position of the user and the position of the others.

Then, the control module 13 sets a privacy information region in the display image and sets a viewing angle of the privacy information region (step S31). For example, when a plurality of windows containing the privacy information is distributed at different positions of the display image, a plurality of privacy information regions is set in the display image. When others are close to the user, a narrow viewing angle is set. When others are away from the user, a large viewing angle is set. When the viewing angle and a range of the privacy information region are set, the display image analyzing module 12 continually detects whether an area or a position of the privacy information region is changed (step S40), if it is detected that area or the position of the privacy information region is changed, a step S50 is executed, by which the control module 13 correspondingly changes the area or the position of the privacy protecting region, so as to set a new privacy information region in the display image.

In summary, the display device and the privacy protecting method thereof of the embodiments of the invention may integrate the PDLC, the GPS positioning device, the height detector, the image detector, etc. in the system through software, and automatically detect whether an application has specific privacy information according to an actual environment condition, so as to adjust a viewing angle of a part of region of the display image to achieve the effect of privacy protection.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A privacy protecting method of a display device, comprising:
analyzing a display image on a display panel so as to determine at least one privacy information region in the display image;
configuring at least one privacy protecting region on a privacy protecting mask according to at least one of a first area and a first position of the at least one privacy information region, so that a viewing angle of the privacy information region is limited by the at least one privacy protecting region of the privacy protecting mask, and a viewing angle of other region in the display image is not limited;
detecting whether at least one of the first area and the first position is changed; and
changing at least one of a second area and a second position of the at least one privacy protecting region of the privacy protecting mask in case that at least one of the first area and the first position of the at least one privacy information region is changed.

2. The privacy protecting method as claimed in claim 1, further comprising:
detecting a position of the display device; and
determining whether to activate the privacy protecting mask according to the position of the display device.

3. The privacy protecting method as claimed in claim 2, wherein the step of detecting the position of the display device comprises:
determining a horizontal position of the display device by a positioning circuit; and
determining a height of the display device by a height detecting circuit,
wherein the position of the display device comprises the horizontal position and the height.

4. The privacy protecting method as claimed in claim 2, wherein the step of detecting the position of the display device comprises:
capturing an environment image of the display device by an image sensing circuit;
obtaining at least one position feature from the environment image; and
determining the position of the display device according to the at least one position feature.

5. The privacy protecting method as claimed in claim 2, wherein the step of detecting the position of the display device comprises:
providing position information of the display device by a positioning circuit;
downloading at least one streetscape map from the Internet according to the position information;
capturing an environment image of the display device by an image sensing circuit;
comparing the environment image with the at least one streetscape map to obtain a comparison result; and
determining the position of the display device according to the position information and the comparison result.

6. The privacy protecting method as claimed in claim 1, further comprising:
determining whether the display image has at least one privacy information feature; and
configuring the at least one privacy information region in the display image according to the at least one privacy information feature, wherein the at least one privacy information feature is located in the at least one privacy information region.

7. The privacy protecting method as claimed in claim 6, wherein the at least one privacy information feature comprises a text or an image of a password, an account number, log in, register, a name, a birthday, a verification code, confidential or an identification number.

8. The privacy protecting method as claimed in claim 1, further comprising:
creating a mask database, wherein the mask database is configured to record a privacy protecting strategy of at least one application;
updating the privacy protecting strategy of the mask database according to a usage course of a user; and
determining whether to activate the privacy protecting mask according to the privacy protecting strategy of the mask database.

9. The privacy protecting method as claimed in claim 1, further comprising:
photographing a user by an image sensing circuit to obtain a captured image
detecting the captured image to obtain a user position of the user in the captured image; and
controlling the privacy protecting mask according to the user position to correspondingly adjust a viewing angle of the at least one privacy information region.

10. The privacy protecting method as claimed in claim 9, wherein the step of adjusting the viewing angle comprises:
adjusting a voltage applied to the at least one privacy protecting region of the privacy protecting mask, so as to adjust the viewing angle of the at least one privacy information region.

11. The privacy protecting method as claimed in claim 10, wherein the privacy protecting mask is a polymer dispersed liquid crystal film integrated with the display panel.

12. The privacy protecting method as claimed in claim 9, further comprising:
detecting the captured image to obtain at least one other people position of at least one other people in the captured image; and
controlling the privacy protecting mask according to the at least one other people position to correspondingly adjust the viewing angle of the at least one privacy information region.

13. The privacy protecting method as claimed in claim 9, further comprising:
detecting whether at least one other people exists in the captured image besides the user; and
controlling the privacy protecting mask to make the at least one privacy information region to be invisible when the at least one other people exists in the captured image.

14. A display device, comprising:
a display panel, configured to display a display image;
a display image analyzing module, configured to analyze the display image to determine at least one privacy information region in the display image;
a privacy protecting mask, disposed on the display panel; and
a control module, coupled to the display panel, the display image analyzing module and the privacy protecting mask, wherein the control module configures at least one privacy protecting region in the privacy protecting mask according to at least one of a first area and a first position of the at least one privacy information region, so that a viewing angle of the at least one privacy information region is limited by the at least one privacy protecting region of the privacy protecting mask, and a viewing angle of other region in the display image is not limited, the control module detects whether at least one of the first area and the first position is changed, if it is detected that at least one of the first area and the first position of the at least one privacy information region is changed, the control module accordingly changes at least one of a second area and a second position of the at least one privacy protecting region of the privacy protecting mask.

15. The display device as claimed in claim 14, further comprising:
a position detecting circuit, coupled to the control module, and configured to detect a position of the display device,
wherein the control module determines whether to activate the privacy protecting mask according to the position of the display device.

16. The display device as claimed in claim 15, wherein the position detecting circuit comprises:
a positioning circuit, coupled to the control module, and configured to determine a horizontal position of the display device; and
a height detecting circuit, coupled to the control module, and configured to determine a height of the display device,
wherein the control module determines whether to activate the privacy protecting mask according to the horizontal position and the height.

17. The display device as claimed in claim 15, wherein the position detecting circuit comprises:
an image sensing circuit, coupled to the control module, and configured to capture an environment image of the display device,
wherein the control module obtains at least one position feature from the environment image, and the control module determines the position of the display device according to the at least one position feature.

18. The display device as claimed in claim 15, wherein the position detecting circuit comprises:
a positioning circuit, coupled to the control module, and configured to provide position information of the display device;
a communication circuit, coupled to the control module, and configured to download at least one streetscape map from the Internet according to the position information; and
an image sensing circuit, coupled to the control module, and configured to capture an environment image of the display device,
wherein the control module compares the environment image with the at least one streetscape map to obtain a comparison result, and determines the position of the display device according to the position information and the comparison result.

19. The display device as claimed in claim 14, wherein the control module determines whether the display image has at least one privacy information feature, and the control module configures the at least one privacy information region in the display image according to the at least one privacy information feature, wherein the at least one privacy information feature is located in the at least one privacy information region.

20. The display device as claimed in claim 19, wherein the at least one privacy information feature comprises a text or an image of a password, an account number, log in, register, a name, a birthday, a verification code, confidential or an identification number.

21. The display device as claimed in claim 14, further comprising:
a mask database, configured to record a privacy protecting strategy of at least one application,
wherein the control module updates the privacy protecting strategy of the mask database according to a usage course of a user, and the control module determines whether to activate the privacy protecting mask according to the privacy protecting strategy of the mask database.

22. The display device as claimed in claim 14, further comprising:
an image sensing circuit, coupled to the control module, and configured to photograph a user to obtain a captured image,
wherein the control module detects the captured image to obtain a user position of the user in the captured image, and the control module controls the privacy protecting mask according to the user position to correspondingly adjust a viewing angle of the at least one privacy information region.

23. The display device as claimed in claim 22, wherein the control module adjusts a voltage applied to the at least one privacy protecting region of the privacy protecting mask, so as to adjust the viewing angle of the at least one privacy information region.

24. The display device as claimed in claim 23, wherein the privacy protecting mask is a polymer dispersed liquid crystal film integrated with the display panel.

25. The display device as claimed in claim 22, wherein the control module detects the captured image to obtain at least one other people position of at least one other people in the captured image, and the control module controls the privacy protecting mask according to the at least one other people position to correspondingly adjust the viewing angle of the at least one privacy information region.

26. The display device as claimed in claim 22, wherein the control module detects whether at least one other people exists in the captured image besides the user, and the control module controls the privacy protecting mask to make the at least one privacy information region to be invisible when the at least one other people exists in the captured image.

27. A privacy protecting method of a display device, comprising:
detecting a position of a display device; and
determining whether to activate a privacy protecting mask to limit a viewing angle of at least one privacy information region in a display image of a display panel according to the position of the display device.

28. The privacy protecting method as claimed in claim 27, wherein the step of detecting the position of the display device comprises:
determining a horizontal position of the display device by a positioning circuit; and
determining a height of the display device by a height detecting circuit.

29. The privacy protecting method as claimed in claim 27, wherein the step of detecting the position of the display device comprises:
capturing an environment image of the display device by an image sensing circuit;
obtaining at least one position feature from the environment image; and
determining the position of the display device according to the at least one position feature.

30. The privacy protecting method as claimed in claim 27, wherein the step of detecting the position of the display device comprises:
providing position information of the display device by a positioning circuit;
downloading at least one streetscape map from the Internet according to the position information;
capturing an environment image of the display device by an image sensing circuit;
comparing the environment image with the at least one streetscape map to obtain a comparison result; and
determining the position of the display device according to the position information and the comparison result.

31. A display device, comprising:
a display panel, configured to display a display image;
a privacy protecting mask, disposed on the display panel;
a position detecting circuit, configured to detect a position of the display device; and
a control module, coupled to the display panel, the privacy protecting mask and the position detecting circuit, and configured to determine whether to activate the privacy protecting mask to limit a viewing angle of at least one privacy information region in the display image of the display panel according to the position of the display device.

32. The display device as claimed in claim 31, wherein the position detecting circuit comprises:
a positioning circuit, coupled to the control module, and configured to determine a horizontal position of the display device; and
a height detecting circuit, coupled to the control module, and configured to determine a height of the display device,
wherein the control module determines whether to activate the privacy protecting mask according to the horizontal position and the height.

33. The display device as claimed in claim 31, wherein the position detecting circuit comprises:
an image sensing circuit, coupled to the control module, and configured to capture an environment image of the display device,
wherein the control module obtains at least one position feature from the environment image, and the control module determines the position of the display device according to the at least one position feature.

34. The display device as claimed in claim 31, wherein the position detecting circuit comprises:
a positioning circuit, coupled to the control module, and configured to provide position information of the display device;
a communication circuit, coupled to the control module, and configured to download at least one streetscape map from the Internet according to the position information; and
an image sensing circuit, coupled to the control module, and configured to capture an environment image of the display device,
wherein the control module compares the environment image with the at least one streetscape map to obtain a comparison result, and the control module determines the position of the display device according to the position information and the comparison result.
